(19) United States
(12) Patent Application Publication
(10) Pub. No.: US 2003/0215566 A1
(43) Pub. Date: Nov. 20, 2003

(54) Fine patterning and fine solid via process for multi-layer substrate

(76) Inventors: Moriss Kung, Taipei (TW); Kwun-Yao Ho, (US)

Correspondence Address: Raymond Sun, 12420 Woodhall Way, Tustin, CA, 92782, US

(21) Appl. No.: 10/269,769

(22) Filed: Oct. 14, 2002

(30) Foreign Application Priority Data
May 20, 2002 (TW) 91110466

(51) Int. Cl. B05D 5/12; B05D 1/32; B05D 1/36

(52) U.S. Cl. 427/96; 427/282; 427/402

(57) ABSTRACT

A fine patterning and fine solid via process with printing method for multi-layer substrate, which including the following steps, providing a substrate which is completed from the pre-process; placing a dielectric layer on at least one surface of the substrate; defining via and circuit on the dielectric layer with the laser ablation; printing the surface of the dielectric layer with sub-micro conductive paste and stuffing said via and circuit on the dielectric layer to form complete via and circuit structure. Finally, proceeding the planarization process on the conductive paste placed on the surface of the substrate to form the complete conductive circuit and via structure at the same time.

### BACKGROUND OF THE INVENTION

(a) Field of the Invention

The present invention relates to fine patterning and fine solid via process for multi-layer substrate. Especially, the present invention relates to fine patterning and fine solid via process with printing method that uses conductive paste below micro scale applying on the integrated circuit substrate to stuff the vias and through holes on the dielectric layer and to form the pattern including circuits and pads.

(b) Description of the Prior Art

As the electronic product getting smaller and lighter, the circuit board and the substrate manufacturer now are facing the strict requirement for precise multiple layers integrated circuit substrate. The circuit layout placed on the substrate is using the vias and the through holes to connect and conduct each other. Basically, the through hole is fully penetrating through a substrate, while a via is not when several substrates added together. In general, the diameter of the via or the through hole is less than 100 μm and its line width is less than 30 μm. However, for the purpose of the density and the precision, the technology for manufacturing the micro via or the through hole with high density and high precision on the single or multiple layers integrated circuit substrate has been developed rapidly. And as the circuit board being widely used, with higher depth/width ratio, manufacturing through hole with good electrical characteristic on a substrate with high precision is the major concern for many manufacturers.

Please refer to FIG. 1A to FIG. 1E, which showing the manufacture process to produce the via on an integrated circuit substrate in prior art, as shown, the process is including the steps as follows:

(a) providing a base as the main body of integrated circuit substrate 10, and on the top and the bottom side of the integrated circuit substrate 10, placing the top and bottom metal layers 11 and 12 used to define the circuit layout later;

(b) allocating the position of the through holes on the predetermined position on the surface of the integrated circuit substrate 10, punching by the mechanical drilling to form a plurality of through holes 13 on the integrated circuit substrate 10;

(c) plating a complete plane with copper 14 in the inner side of the through holes 13 to form the electrical conducting through holes (Plated Trough Hole) 13a;

(d) proceeding Photolithograph, etching process on the circuit structure that being defined on the top and the bottom metal layer 11 and 12 on the top and the bottom surface of the integrated circuit substrate 10 to define the top and the bottom circuit layer 11a and 12a.

(e) proceeding the filling process on the through hole 13a by filling up the through hole 13a with a resin material such as the solder mask to form the complete structure of conducting plug 14, and the last step is to place the protection layer on the surface of the top and the bottom circuit layer 11a and 12a of the integrated circuit substrate 10 for protection purpose.

The description above is the general manufacturing process for a two-layer integrated circuit substrate. Basically, defining the through holes in the aforesaid process for the single layer integrated circuit substrate and stacking the two-layer integrated circuit substrates together will form the complex multiple layers integrated circuit substrate.

The process described above has been developed for many years in prior art, however, the disadvantages still exist; such as bad reliability, bad yield and so on. The major causes are as follows,

1. The electroplating seems the inevitable method to define the circuit pattern, the through hole and the blind via for a substrate in prior art, which is complex and expensive.

2. The solder mask is the most common used material in filling process fro the through hole 14, it is easy to form the gap space in the conducting plug 15 and to produce the popcorn, and further cause the difficulties of filling, the limitation of the diameter of the via, bad quality of electrical connection and bad reliability.

3. Making high quality via is an extremely complex process, the time for making such product is much longer, the manufacturing facility needed is expensive and the manufacturing cost is also high.

As the descriptions, the integrated circuit substrate that being made thru the conventional process is with the weakness such as bad reliability and bad intensity in the conducting plug, it always fails to meet the requirement from customer, also, the market competition is weak and the production cost is high. Therefore, the improvement of the process for producing better vias on the integrated circuit substrate is the major concern that every substrate manufacturer focused.

### SUMMARY OF THE INVENTION

The primary aspect of the present invention is to provide fine patterning and fine solid via process with printing method for multi-layer substrate, which uses conductive paste below micro scale applying on the integrated circuit substrate to stuff the vias and through holes on the dielectric layer and to form the pattern including circuits and pads.

The second aspect of the present invention is to provide fine patterning and fine solid via process with printing method for multi-layer substrate, which uses nano-scale conductive paste; such as NP series product from HARIMA, CHEMICALS of Japan, applying on the integrated circuit substrate to stuff the micro vias and through holes on the dielectric layer, and planarizing these vias, through holes and pattern to complete the process.

The third aspect of the present invention is to provide fine patterning and fine solid via process with printing method for multi-layer substrate, which uses the conductive paste for filling directly to make the through hole, therefore, the extra capture pad is not necessary, nor is the expensive production facility, meanwhile, the density of the layout of the circuit will be increased and the quality of the substrate is much better.

In order to achieve the objects described above, the present invention is to provide fine patterning and fine solid via process with printing method for multi-layer substrate, which comprises the following steps:

(a). providing a substrate which is completed from a pre-process;

(b). placing a dielectric layer on at least a surface of the substrate;

(c). defining the corresponding position of the vias and the circuit on the dielectric layer;

(d). applying the sub-micro conductive paste with printing method on the surface of the dielectric layer, stuffing the vias and the circuit to make the complete vias and circuit. Wherein the sub-micro conductive paste is also including the sub-nano one;

(e). flatting the conductive paste placed on the surface of the substrate to form the vias and circuit structure at the same time with the conductive paste that being placed there around.

The aforesaid steps can be repeated a few times to build up more dielectric layers; which is so called “Build-Up” process, and further, the PR Coating, the Exposure/Developing, the Photolithography and the Curing will apply respectively. And the pads can be made by the electrical plating with various metals on the predetermined positions.

Preferably, the procedures described above can be repeated many times to form the vias and the micro circuit pattern.

Preferably, a release protection sheet can be placed first to define the vias, and which can be removed after filling the conductive paste.

### BRIEF DESCRIPTION OF THE DRAWINGS

FIG. 1A to FIG. 1D show the pattern formation process for an integrated circuit substrate in prior art.

FIG. 2 to FIG. 10 show the first embodiment of the fine patterning and fine solid via process with printing method for multi-layer substrate of the present invention.

FIG. 6A shows one embodiment of the planarization for the first embodiment of the fine patterning and fine solid via process with printing method for multi-layer substrate of the present invention.

FIG. 6B shows another embodiment of the planarization for the first embodiment of the fine patterning and fine solid via process with printing method for multi-layer substrate of the present invention.

FIG. 6C shows the third embodiment of the planarization for the first embodiment of the fine patterning and fine solid via process with printing method for multi-layer substrate of the present invention.

FIG. 11 to FIG. 19 show the second embodiment of the fine patterning and fine solid via process with printing method for multi-layer substrate of the present invention.

FIG. 20 to FIG. 29 show the third embodiment of the fine patterning and fine solid via process with printing method for multi-layer substrate of the present invention.

FIG. 30 to FIG. 40 show the fourth embodiment of the fine patterning and fine solid via process with printing method for multi-layer substrate of the present invention.

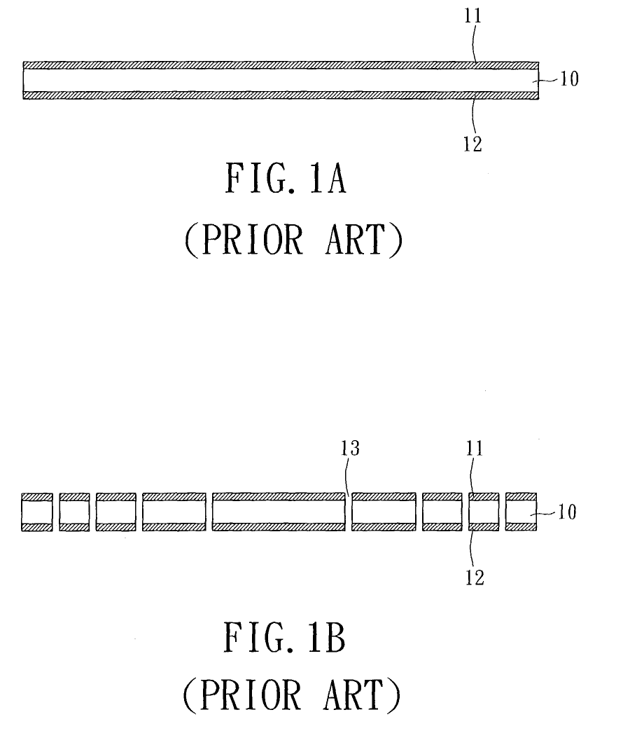

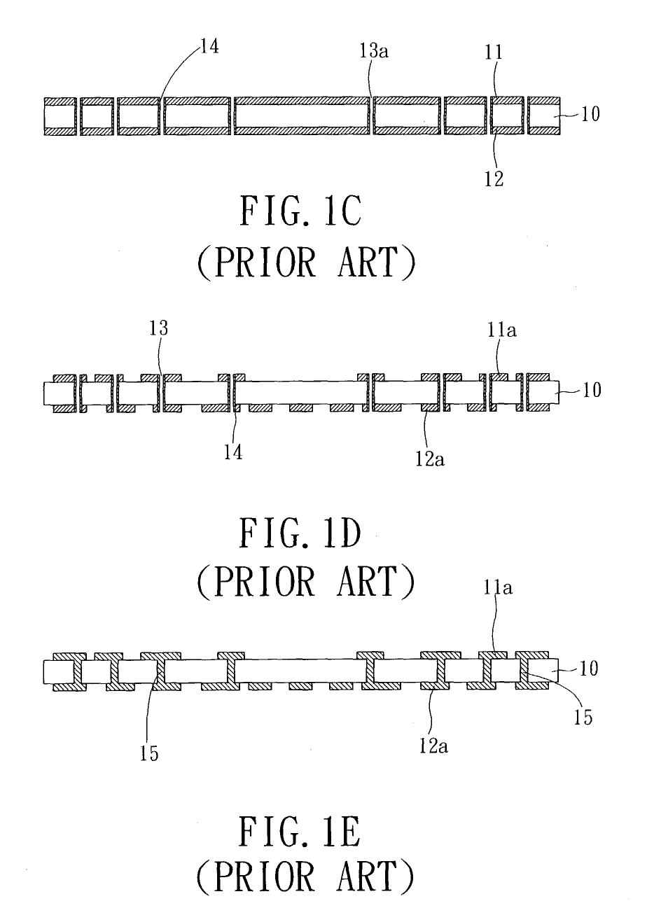

### DETAILED DESCRIPTION OF THE PRESENT INVENTION

The following embodiments will describe the fine patterning and fine solid via process with printing method for multi-layer substrate of the present invention about the detailed evolvement, the effect and the other technical characteristics. Various possible modification, omission, and alterations could be conceived of by one skilled in the art to the form and the content of any particular embodiment, without departing from the scope and the spirit of the present invention.

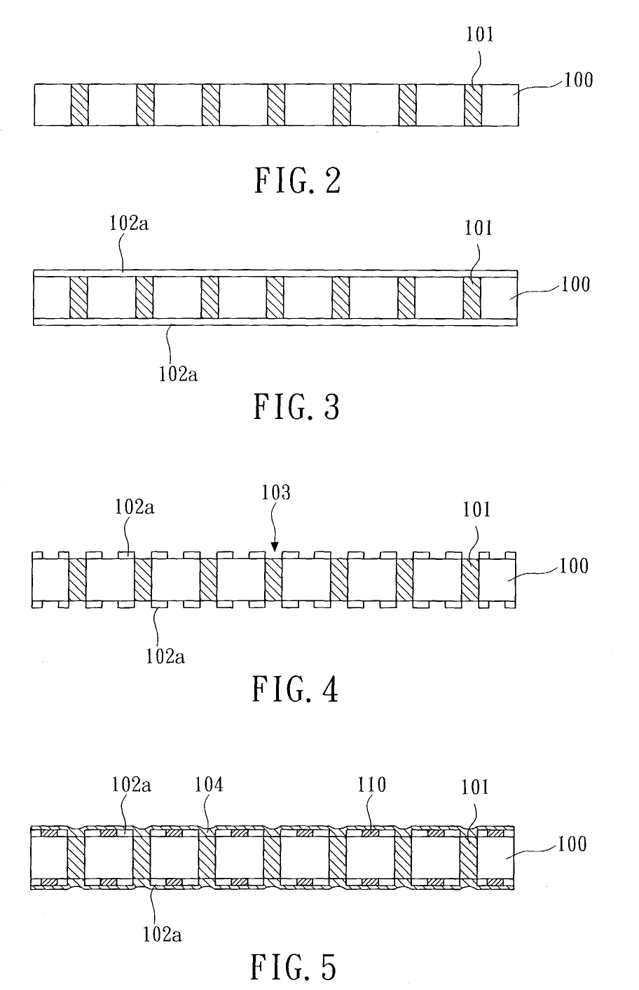

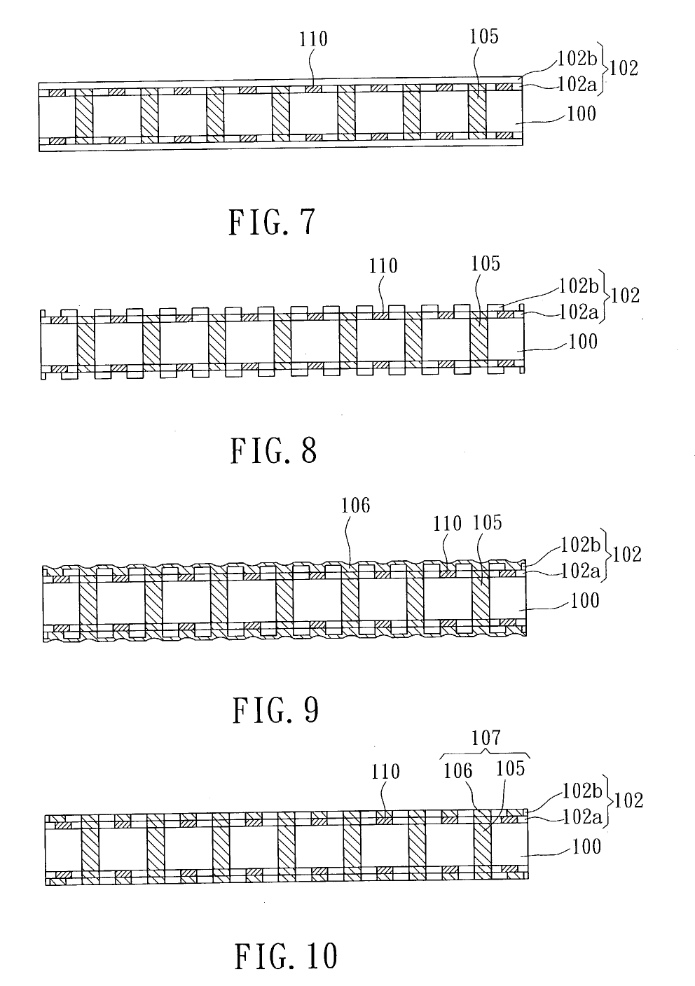

Please refer to FIG. 2 to FIG. 10, which are showing the first embodiment of the fine patterning and fine solid via process with printing method for multi-layer substrate of the present invention, which comprising,

(a) providing one unit substrate 100 which can be a ceramic substrate, a plastic substrate or a soft material substrate. The ceramic substrate uses the ceramic material as isolation while the plastic substrate uses the plastic material as isolation. And the substrate 100 is the common one adapted in the industry, generally, the material for the plastic substrate is epoxy resin FR-4, BMI, BT-based resin, teflon, LCP, or polyimide. And on the predetermined position of the substrate 100, a few through hole structure penetrating through the substrate 100 will be made by the mechanical drilling/punching and the through hole will be stuffed with the conductive paste to form the vias 101;

(b) placing a dielectric layer 102a on the surface of the substrate 100, which is a photo-imagible dielectric layer (PID);

(c) Then, on the dielectric layer 102a, defining some vias 103 on the corresponding position to the via 101, whereby the process of the Photolithography and the Curing could be used;

(d) placing the sub-micro conductive paste 104 on the surface of the dielectric layer 102a with the printing method, stuffing the vias 103 on the dielectric layer 102a to form the complete through holes and the circuit 110. Wherein the sub-micro conductive paste 104 is including the sub-nano one; such as the NP series product from HARIMA, CHEMICALS of Japan, the material could be copper paste, silver paste, conductive carbon paste or any other kind of metal;

(e) proceeding the planarization on the conductive paste 104 on the surface of the substrate 100 to integrate the via structure 101 with the conductive paste 104 placed around the via 103 to form a complete via 105. And the method of the planarization could be:

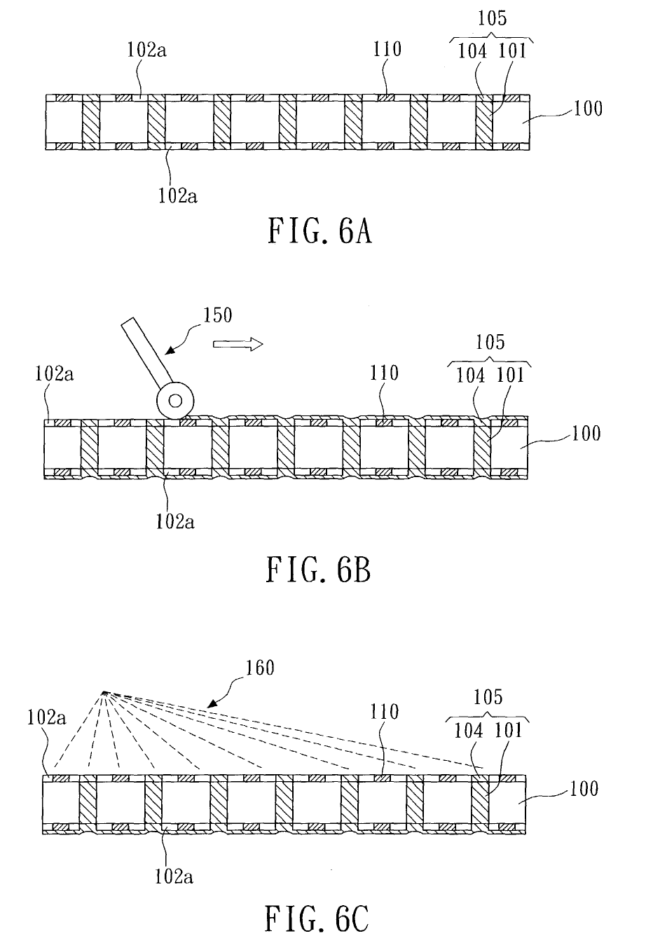

(e1) the grinding, the CMP or the surface uniform etching process (SUEP) as shown in FIG. 6A;

(e2) with roller device 150, which could be a roller one or a paste absorber one as shown in FIG. 6B;

(e3) the solvent spray cleaning 160, and the solvent used here could be Butylcellulose or Ether-Alcohol, and the high speed spinning of the substrate 100 will be incorporated as shown in FIG. 6C.

(f) on the via 105 and the dielectric layer 102a, placing an isolation dielectric layer 102b which can be a PID one and can be the same material as the dielectric layer 102a, and will become a new dielectric layer 102 with the layer 102a.

(g) on the dielectric layer 102b, defining some vias on the corresponding position to the via 105, whereby the method of the Exposure, the Photolithography and the Curing could be used;

(h) placing the sub-micro conductive paste 106 on the surface of the dielectric layer 102 with the printing method, stuffing the vias on the dielectric layer 102b to form the complete through holes and the circuit 110. Wherein the sub-micro conductive paste 106 is including the sub-nano one; such as the NP series product from HARIMA, CHEMICALS of Japan, the material could be copper paste, silver paste, conductive carbon paste or any other kind of metal;

(i) proceeding the planarization on the conductive paste 106 on the most outside surface of the substrate 100 to integrate the via structure 105 with the conductive paste 106 placed around the via 105 to form a complete via 107. And the method of the planarization could be the grinding, the CMP or the surface uniform etching process (SUEP).

(j) next, as in the conventional process of making a substrate, the build-up process will be adapted to produce a multiple layers substrate. Finally, the PR Coating, the Photolithography and the Curing will be applied respectively. And the pads can be made by the electrical plating with various metals on the predetermined positions. However, these are skills in prior art, and are not the areas covered in this specification.

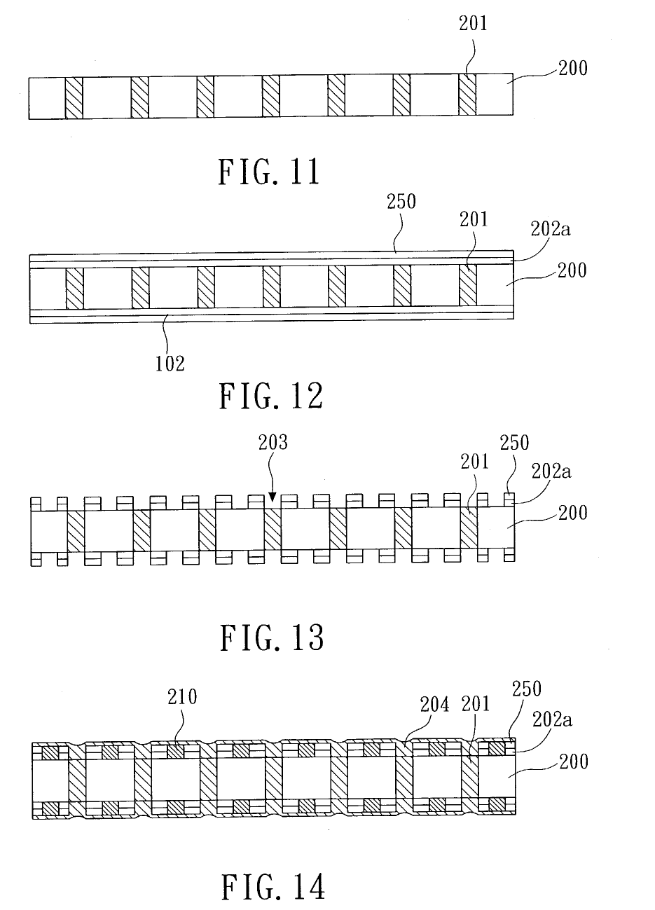

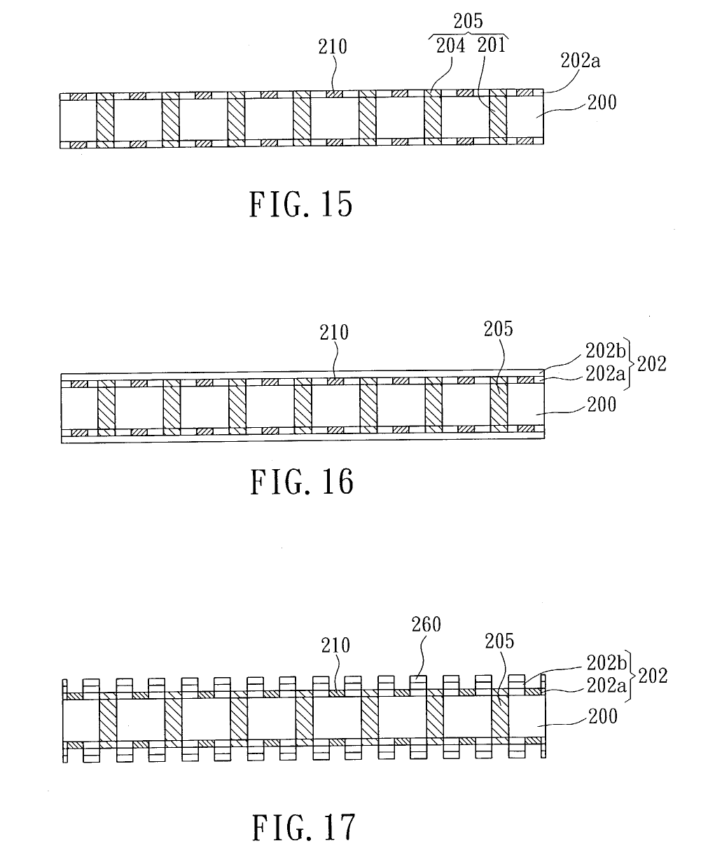

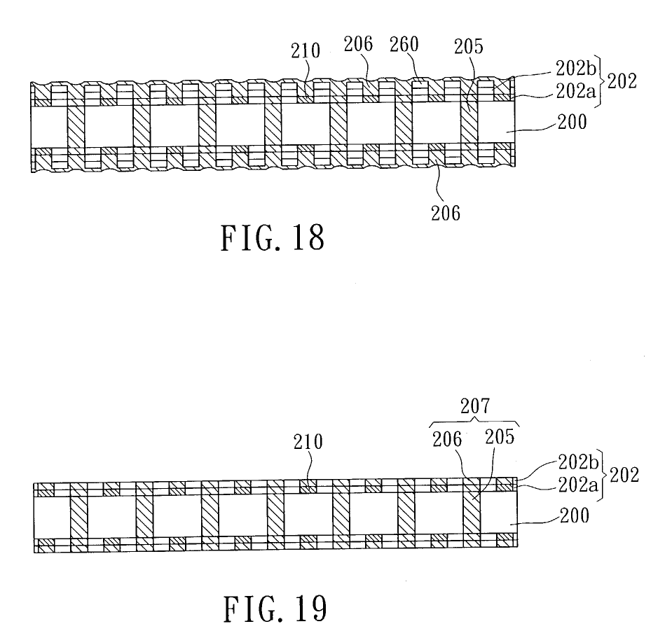

Please refer to FIG. 11 to FIG. 19, which are showing the second embodiment of the fine patterning and fine solid via process with printing method for multi-layer substrate of the present invention, which comprising,

(a) providing one unit substrate 200 which is with same material as described in the first embodiment. More descriptions will not be necessary. And on the predetermined position of the substrate 200, a few through hole structure penetrating through the substrate 200 will be made by the mechanical drilling/punching and the through hole will be stuffed with the conductive paste to form the vias 201;

(b) placing a dielectric layer 202a on the surface of the substrate 200 and a release film 250 for protection, wherein the dielectric layer is a laserable dielectric one;

(c) then, on the dielectric layer 202a, defining some vias 203 on the corresponding position to the via 201 with the laser ablation method;

(d) as illustrated in the first embodiment, placing the sub-micro conductive paste 204 on the surface of the dielectric layer 202a with the printing method, stuffing the vias 203 on the dielectric layer 202a to form the complete through holes and the circuit 210. Wherein the sub-micro conductive paste 204 is including the sub-nano one; such as the NP series product from HARIMA, CHEMICALS of Japan, the material could be copper paste, silver paste, conductive carbon paste or any other kind of metal;

(e) releasing the release film 205, proceeding the planarization on the conductive paste 204 on the surface of the substrate 200 to integrate the via structure 201 with the conductive paste 204 placed around the via 203 to form a complete via 205.

(f) on the via 205 and the dielectric layer 202a, placing an isolation dielectric layer 202b which can be a laserable one and can be the same material as the dielectric layer 202a, and will become a new dielectric layer 102 with the layer 202a.

(g) placing a release film 260 for protection, and, on the release film 260 and the dielectric layer 202b, defining some vias on the corresponding position to the via 205 with the laser ablation method.

(h) placing the sub-micro conductive paste 206 on the surface of the dielectric layer 202 with the printing method, stuffing the vias on the dielectric layer 202b to form the complete through holes. Wherein the sub-micro conductive paste 206 is including the sub-nano one; such as the NP series product from HARIMA, CHEMICALS of Japan, the material could be copper paste, silver paste, conductive carbon paste or any other kind of metal;

(i) releasing the release film 260;

(j) next, the build-up process will be adapted to produce a multiple layers substrate. Finally, the PR Coating, the Photolithography and the Curing will be applied respectively, and the pads can be made by the electrical plating on the predetermined positions; as described in the first embodiment.

In practice, this method used in this embodiment also can be adapted in the build-up process to produce a multiple layers substrate, and since the release film is used as a protection sheet, the extra procedures will not be necessary after the film being removed.

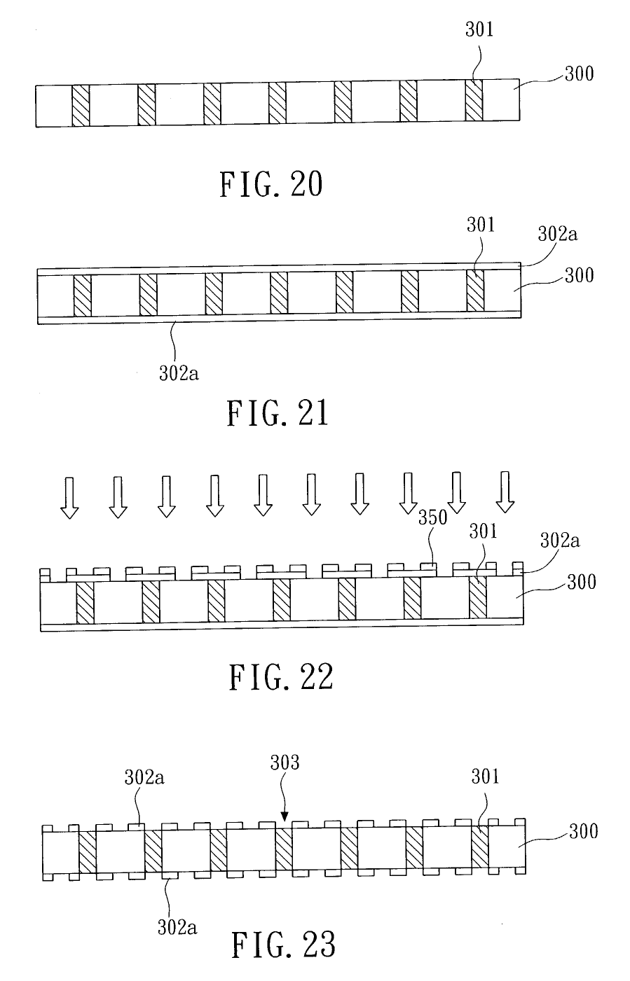

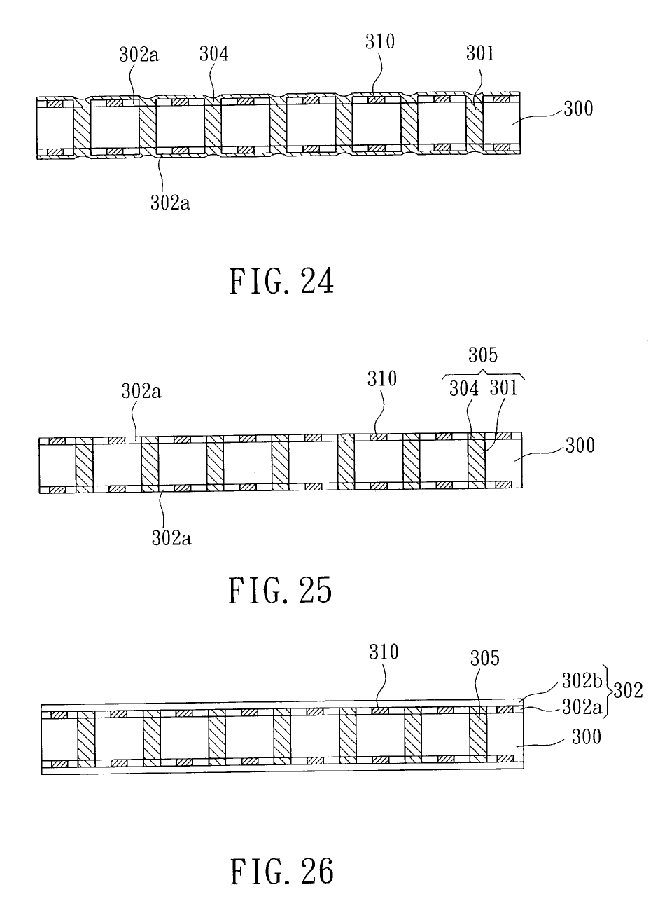

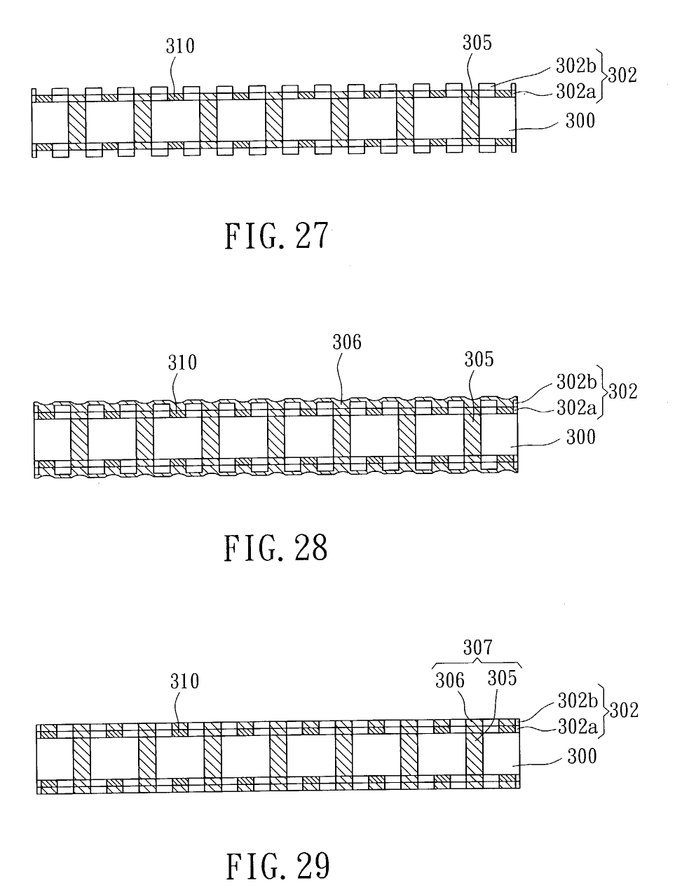

Please refer to FIG. 20 to FIG. 29, which are showing the third embodiment of the fine patterning and fine solid via process with printing method for multi-layer substrate of the present invention, which comprising,

(a) providing one unit substrate 300 which is with same material as described in the first embodiment. More descriptions will not be necessary. And on the predetermined position of the substrate 300, a few through hole structure penetrating through the substrate 300 will be made by the mechanical drilling/punching and the through hole will be stuffed with the conductive paste to form the vias 301;

(b) placing a dielectric film 302a on the surface of the substrate 300;

(c) placing a metal mask pattern 350 on the dielectric film 302a, on the film 302a, defining some vias 303 on the corresponding position to the via 301 with the laser ablation method, then, removing the metal mask pattern 350. Certainly, the metal mask pattern is optional; the laser ablation can be applied directly. The FIG. 21 is only showing the process for one side, same process can be applied on another side.

(d) placing the sub-micro conductive paste 304 on the surface of the dielectric film 302a with the printing method, stuffing the vias 303 on the dielectric layer 302a to form the complete through holes and the circuit 310. Wherein the sub-micro conductive paste 304 is including the sub-nano one; such as the NP series product from HARIMA, CHEMICALS of Japan, the material could be copper paste, silver paste, conductive carbon paste or any other kind of metal;

(e) proceeding the planarization on the conductive paste 304 on the surface of the substrate 300 to integrate the via structure 301 with the conductive paste 304 placed around the via 303 to form a complete via 305. The method of planarization can be the grinding, the CMP, the surface uniform etching process (SUEP), the method with roller device which could be a roller one or a paste absorber one, the solvent spray cleaning with the high speed spinning of the substrate 300;

(f) on the via 305 and the dielectric film 302a, placing an isolation dielectric film 302b which can be the same material as the dielectric film 302a, and will become a new dielectric layer 302 with the layer 302a.

(g) on the release film 302b, defining some vias on the corresponding position to the via 305 with the laser ablation method.

(h) placing the sub-micro conductive paste 306 on the surface of the dielectric layer 302 with the printing method, stuffing the vias on the dielectric layer 302b to form the complete through holes. Wherein the sub-micro conductive paste 306 is including the sub-nano one; such as the NP series product from HARIMA, CHEMICALS of Japan, the material could be copper paste, silver paste, conductive carbon paste or any other kind of metal;

(i) proceeding the planarization on the conductive paste 306 on the most outside surface of the substrate 300 to integrate the via structure 305 with the conductive paste 306 placed around the via 305 to form a complete via 307. The method of planarization can be the grinding, the CMP, the surface uniform etching process (SUEP), the method with roller device which could be a roller one or a paste absorber one, the solvent spray cleaning with the high speed spinning of the substrate 300.

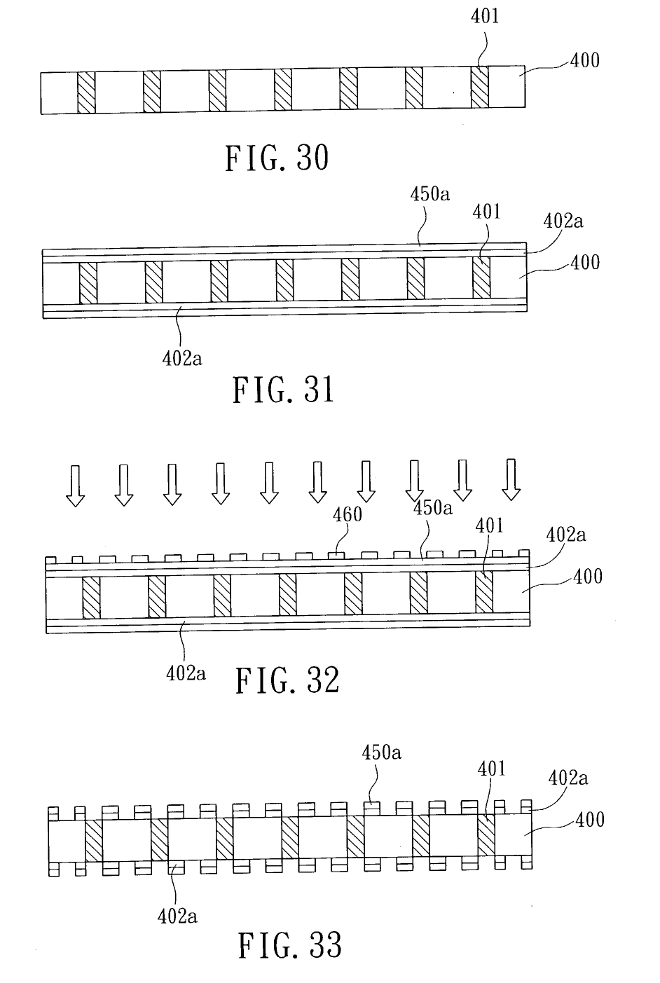

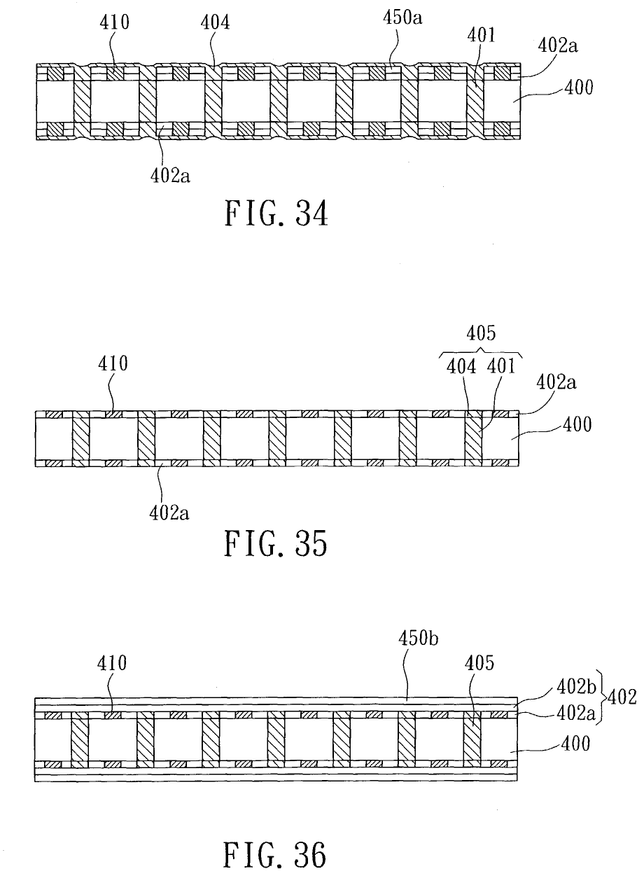

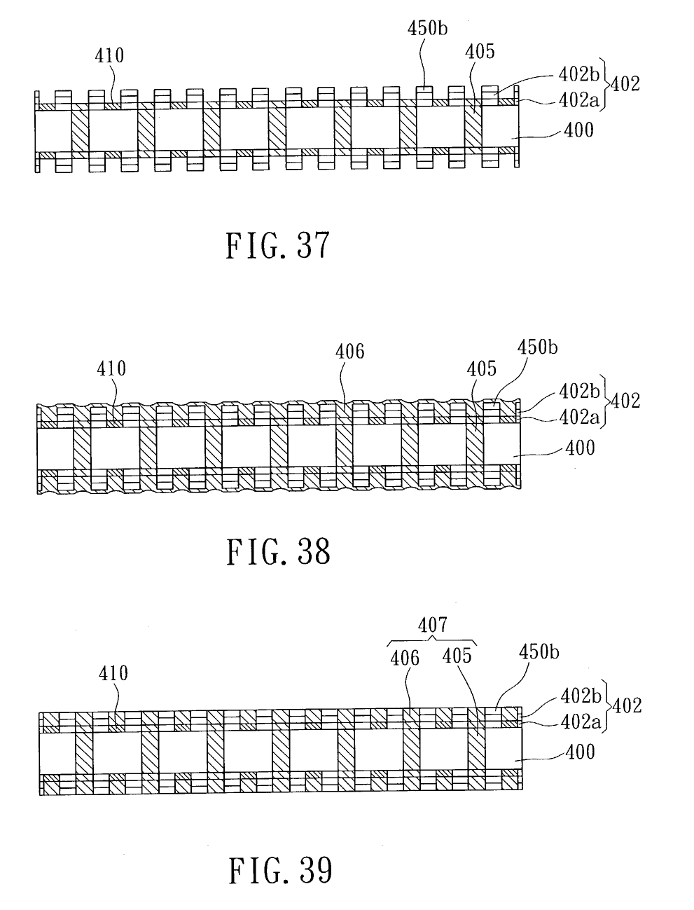

Please refer to FIG. 30 to FIG. 40, which are showing the fourth embodiment of the fine patterning and fine solid via process with printing method for multi-layer substrate of the present invention, which comprising,

(a) on the predetermined position of the substrate 400, a few through hole structure penetrating through the substrate 400 will be made by the mechanical drilling and the through hole will be stuffed by the stuffing procedures to form the vias 401;

(b) placing a dielectric film 402a and the release film 450a on the surface of the substrate 400;

(c) placing a metal mask pattern 460 on the release film 450a, on the release film 450a and the dielectric film 402a, defining some vias 403 on the corresponding position to the via 401 with the laser ablation method, then, removing the metal mask pattern 450. Certainly, the metal mask pattern is optional; the laser ablation can be applied directly.

(d) placing the sub-micro conductive paste 404 on the surface of the dielectric film 402a with the printing method, stuffing the vias 403 on the dielectric layer 402a to form the complete through holes and the circuit 410. Wherein the sub-micro conductive paste 404 is including the sub-nano one; such as the NP series product from HARIMA, CHEMICALS of Japan, the material could be copper paste, silver paste, conductive carbon paste or any other kind of metal;

(e) removing the release film 450a, proceeding the planarization on the conductive paste 404 on the surface of the substrate 400 to integrate the via structure 401 with the conductive paste 404 placed around the via 403 to form a complete via 405.

(f) on the via 405 and the dielectric film 402a, placing an isolation dielectric film 402b and a release film 450b, the dielectric film 402b can be the same material as the dielectric film 402a, and will become a new dielectric layer 402 with the layer 402a.

(g) on the dielectric film 402b and the release film 450b, defining some vias on the corresponding position to the via 405 with the laser ablation method.

(h) placing the sub-micro conductive paste 406 on the surface of the dielectric layer 402 with the printing method, stuffing the vias on the dielectric film 402b and the release film 450b to form the complete through holes. Wherein the sub-micro conductive paste 406 is including the sub-nano one; such as the NP series product from HARIMA, CHEMICALS of Japan, the material could be copper paste, silver paste, conductive carbon paste or any other kind of metal;

(i) removing the release film 450b, proceeding the planarization on the conductive paste 406 on the surface of the substrate 400 to integrate the via structure 405 with the conductive paste 406 placed around the via 305 to form a complete via 407.

As described before, the build-up process will be adapted to produce a multiple layers substrate. Finally, the PR Coating, the Photolithography and the Curing will be applied respectively, and the pads can be made by the electrical plating on the predetermined positions; as described in the first embodiment.

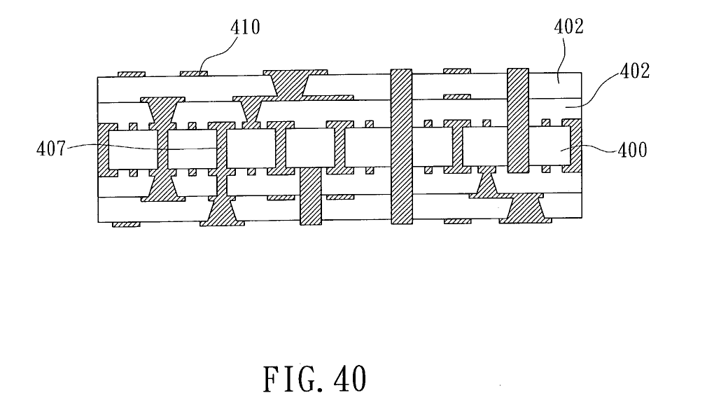

Certainly, the present invention also can be applied in the so-called build-up process. As illustrated in FIG. 40, in the core of a substrate 400, the up and bottom layers of the substrate have been stacked with a few dielectric layers 402 to form a multiple-layers substrate. In the figure, the sub-micro conductive paste has been placed on the dielectric layers and stuffed the vias structure to form some circuit layer 410, the blind via and various through holes 407. The FIG. 40 is only illustrating the up and bottom layers of the substrate, in practice, more layers can be made by the same method.

The major difference in the present invention that differs from prior art is that the present invention adapts the sub-micro conductive paste, even the sub-nano conductive paste, to stuff the via structure, and in the stuffing process, the release film and the metal mask pattern will be used as additional assistance to fill up the via. In stead of stuffing the via with the solder mask directly in prior art, the present invention is able to stuff a extremely tiny via structure including through hole, blind via and tiny circuit pattern but still keep the excellent quality for the substrate.

The description above is completely illustrating the fine patterning and fine solid via process with printing method for multi-layer substrate of the present invention. As illustrated, the present invention uses the conductive paste to process the filling up to form through holes and vias; which will not use extra capture pad and expensive facility but highly increase the density of the circuit layout and the quality of substrate. More over, with the present invention, the manufacturing process is much easier and can be widely used in many fields for various size of substrate, totally overcome the disadvantages in prior art.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. A fine patterning and fine solid via process for multi-layer substrate, which comprising at least the following steps:
(a) providing a substrate which is completed from the pre-process;
(b) placing a dielectric layer on at least one surface of the substrate;
(c) patterning said dielectric layer to define via and circuit;
(d) printing the surface of the dielectric layer with sub-micro conductive paste, and stuffing said via and circuit on the dielectric layer to form complete via and circuit structure.

2. A fine patterning and fine solid via process for multi-layer substrate of claim 1, wherein the sub-micro conductive paste can be sub-nano conductive paste.

3. A fine patterning and fine solid via process for multi-layer substrate of claim 1, wherein the conductive paste can be one of copper paste, silver paste and conductive carbon paste.

4. A fine patterning and fine solid via process for multi-layer substrate of claim 1, wherein the dielectric layer can be photo-imagible dielectric.

5. A fine patterning and fine solid via process for multi-layer substrate of claim 1, wherein, before the step (c), a metal mask pattern can be placed on the dielectric layer.

6. A fine patterning and fine solid via process for multi-layer substrate of claim 1, wherein, before the step (c), a release film can be placed on the surface of the substrate for protection and removing the release film after the stuffing process of the step (d).

7. A fine patterning and fine solid via process for multi-layer substrate of claim 6, wherein, after placing the release film and before the step (c), a metal mask pattern can be placed on the release film.

8. A fine patterning and fine solid via process for multi-layer substrate, which comprising at least the following steps:
(a) providing a substrate which is completed from the pre-process;
(b) placing a dielectric layer on at least one surface of the substrate;
(c) defining via and circuit on the dielectric layer with the laser ablation;
(d) printing the surface of the dielectric layer with sub-micro conductive paste, and stuffing said via and circuit on the dielectric layer to form complete via and circuit structure;
(e) Removing extra conductive paste with the planarization process.

9. A fine patterning and fine solid via process for multi-layer substrate of claim 8, wherein the planarization process is the grinding method.

10. A fine patterning and fine solid via process for multi-layer substrate of claim 8, wherein the planarization process is the CMP method.

11. A fine patterning and fine solid via process for multi-layer substrate of claim 8, wherein the planarization process is the SUEP method.

12. A fine patterning and fine solid via process for multi-layer substrate of claim 8, wherein the planarization process is the roller swiping method.

13. A fine patterning and fine solid via process for multi-layer substrate of claim 8, wherein the planarization process is the paste absorber method.

14. A fine patterning and fine solid via process for multi-layer substrate of claim 8, wherein the planarization process is the solvent spray cleaning method.

15. A fine patterning and fine solid via process for multi-layer substrate of claim 14, wherein the solvent spray cleaning method can incorporate with the high speed spinning substrate.

16. A fine patterning and fine solid via process for multi-layer substrate of claim 8, wherein the sub-micro conductive paste can be sub-nano conductive paste.

17. A fine patterning and fine solid via process for multi-layer substrate of claim 8, wherein the conductive paste can be one of copper paste, silver paste and conductive carbon paste.

18. A fine patterning and fine solid via process for multi-layer substrate of claim 8, wherein the dielectric layer can be photo-imagible dielectric.

19. A fine patterning and fine solid via process for multi-layer substrate of claim 8, wherein, before the step (c), a metal mask pattern can be placed on the dielectric layer.

20. A fine patterning and fine solid via process for multi-layer substrate of claim 8, wherein, before the step (c), a release film can be placed on the surface of the substrate for protection and removing the release film after the stuffing process of the step (d).

21. A fine patterning and fine solid via process for multi-layer substrate of claim 20, wherein, after placing the release film and before the step (c), a metal mask pattern can be placed on the release film.
